(19) United States
(12) Patent Application Publication
(10) Pub. No.: US 2015/0279329 A1
(43) Pub. Date: Oct. 1, 2015

(54) DISPLAY AND METHOD FOR OPERATING FRAMES OF MULTIPLE DEVICES THEREOF

(71) Applicant: Wistron Corporation, New Taipei City (TW)

(72) Inventor: Jun-Xin Qiu, New Taipei City (TW)

(21) Appl. No.: 14/308,722

(22) Filed: Jun. 19, 2014

(30) Foreign Application Priority Data
Mar. 25, 2014 (CN) 201410114237.2

(51) Int. Cl. G09G 5/14; G06F 3/0482

(52) U.S. Cl. CPC G09G 5/14; G06F 3/0482; G09G 2340/12

(57) ABSTRACT

A display and a method for operating frames of multiple devices thereof are provided. In the method, connections between the display and multiple electronic devices are established. Frames output from each electronic device are received through the connections and are displayed on the display. Then, one of the frames is selected as a main control frame according to frame allocating information, and an input signal of an input device is transmitted to the electronic device corresponding to the main control frame. A trigger signal is received to switch the main control frame among the frames, and the input signal of the input device is transmitted to the electronic device corresponding to the switched main frame.

### CROSS-REFERENCE TO RELATED APPLICATION

This application claims the priority benefit of China application serial no. 201410114237.2, filed on Mar. 25, 2014. The entirety of the above-mentioned patent application is hereby incorporated by reference herein and made a part of this specification.

### BACKGROUND

1. Technical Field

The invention relates to a display and a method for operating frames thereof. Particularly, the invention relates to a display and a method for operating frames of multiple devices thereof.

2. Related Art

As people demand electronic products to have different functions, various types of electronic devices are developed, for example, notebook computers and tablet personal computers (PCs) have a characteristic of portability, and smart phones are light and thin and are capable of making phone calls, and these different types of electronic devices can satisfy people's demand on different functions of the electronic products. Moreover, along with progress of display technology, functions of a display are diversified, and based on wired or wireless transmission technique, frames of the electronic devices can be displayed on the display to facilitate a user viewing the frames of the electronic devices.

Generally, the display provides a plurality of connection ports of different specifications, and each of the connection ports supports a transmission interface of a different specification, for example, a video graphics array (VGA) interface, a high-definition multimedia interface (HDMI), a mobility high-definition link (MHL), a universal serial bus (BUS), etc. When the user wants to output the frames of the electronic devices to the display for displaying, the user can connect the electronic devices to the corresponding connection ports of the display according to the supported transmission interface thereof, so as to display the frames on the display. However, the existing technique can only achieve an effect of simultaneously displaying the frames of a plurality of electronic device on the display, and if the user wants to operate the frames, the user can only implement the operation through the individual electronic devices, which is inconvenient. Therefore, how to quickly and effectively operate the frames of the electronic devices is a problem encountered in application of a multi device frame display technique of the display.

### SUMMARY

The invention is directed to a display and a method for operating frames of multiple devices thereof, by which frames of a plurality of electronic devices are displayed on a single display, and a control operation is performed to the frames of different electronic devices by using an input device connected to the display.

The invention provides a method for operating frames of multiple devices, which is adapted for a single display to display frames of a plurality of electronic devices and operate the frame of each of the electronic devices by using an input device. The method includes following steps. A connection between the display and each of the electronic devices is established. The frame output from each of the electronic devices is received through the connection and displayed on the display. Then, one of the frames is selected as a main control frame according to frame allocating information, and an input signal of the input device is transmitted to the electronic device corresponding to the main control frame. A trigger signal is received to switch the main control frame among the frames, and the input signal of the input device is transmitted to the electronic device corresponding to the switched main control frame.

The invention provides a display including a connection device, a display panel, an input device and a processor. The connection device is used for establishing connections with a plurality of electronic devices, and receives frames output from the electronic devices. The display panel is used for displaying the frames received by the connection device. The input device generates an input signal in response to an operation. The processor is coupled to the connection device, the display panel and the input device, and selects one of the frames as a main control frame according to frame allocating information, transmits the input signal to the electronic device corresponding to the main control frame, switches the main control frame among the frames according to a received trigger signal, and transmits the input signal to the electronic device corresponding to the switched main control frame.

According to the above descriptions, in the display and the method for operating frames of multiple devices of the invention, frames of a plurality of electronic devices are displayed on a single display, and the frame corresponding to the electronic device to be controlled is selected as the main control frame, so as to perform control operations on the frame of the electronic device by using the input device. In the invention, the user may use a control key on the display or a hot key on the input device to implement switching of the main control frame. In this way, the user can quickly switch the electronic device to be controlled to implement operations.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of displaying frames of multiple devices on a display according to an embodiment of the invention.

FIG. 2 is a block diagram of a display according to an embodiment of the invention.

FIG. 3 is a flowchart illustrating a method for operating frames of multiple devices according to an embodiment of the invention.

FIG. 4A and FIG. 4B are respectively examples of switching a main control frame among frames of multiple devices according to an embodiment of the invention.

FIG. 5 is a flowchart illustrating a method for operating frames of multiple devices according to an embodiment of the invention.

FIG. 6 is a block diagram of a display according to another embodiment of the invention.

FIG. 7 is a flowchart illustrating a method for operating frames of multiple devices according to another embodiment of the invention.

### DETAILED DESCRIPTION OF DISCLOSED EMBODIMENTS

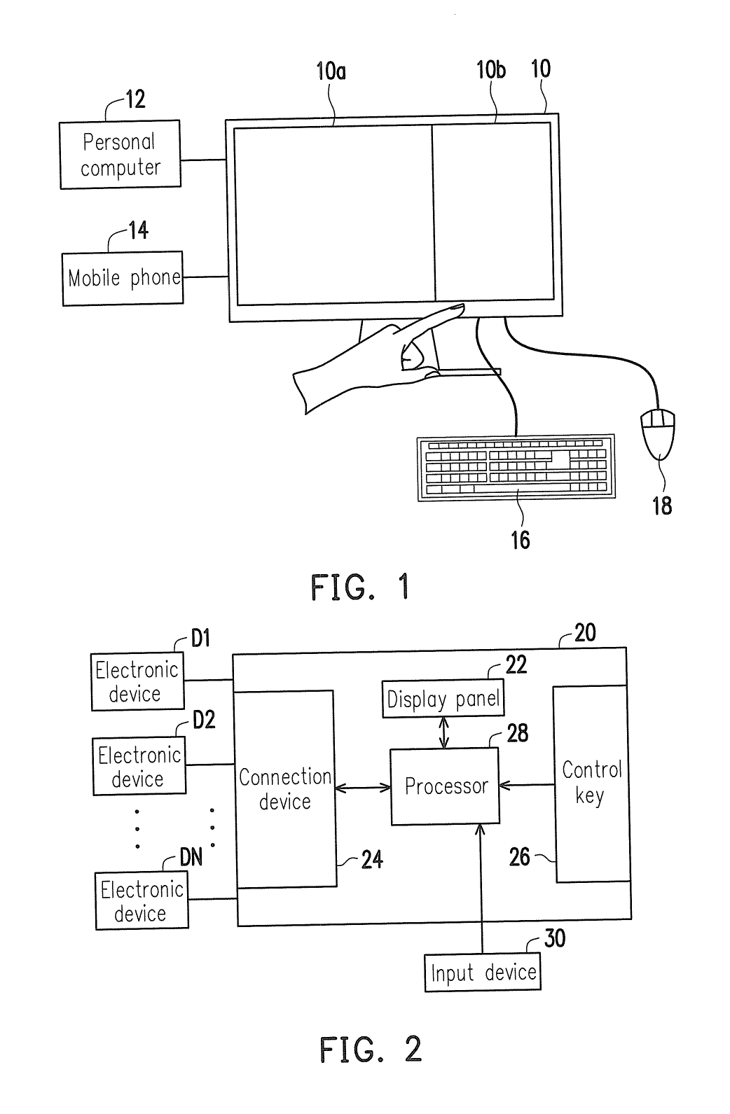

FIG. 1 is a schematic diagram of displaying frames of multiple devices on a display according to an embodiment of the invention. As shown in FIG. 1, the display 10 of the present embodiment is coupled to a plurality of electronic devices, and the electronic devices can be a personal computer (PC), a smart phone, or a tablet PC, etc., that is capable of providing an image streaming. In the present embodiment, the electronic devices coupled to the display 10 are a PC 12 and mobile phone 14, and the display 10 can simultaneously display frames of the PC 12 and the mobile phone 14. For example, the frame of the PC 12 is displayed on a left half display region 10a, and the frame of the mobile phone 14 is displayed on a right half display region 10b.

The display 10 is coupled to input devices. In the present embodiment, the input devices are, for example, a keyboard 16 and a mouse 18, and the user can operate a main control frame by using the input devices, so as to control the electronic device corresponding to the main control frame. In the present embodiment, the main control frame is preset to the left half display region 10a, and the user can operate the frame (corresponding to the PC 12) displayed on the left half display region 10a by using the keyboard 16 or the mouse 18. On the other hand, the user can press a control key on the display 10 or press a hot key on the keyboard 16 or the mouse 18 to select or switch the main control frame, so as to control the electronic device corresponding to the switched main control frame. As shown in FIG. 1, the user can press the control key on the display 10 by hand to switch the main control frame from the frame of the PC 12 (which is displayed on the left half display region 10a) to the frame of the mobile phone 14 (which is displayed on the right half display region 10b).

FIG. 2 is a block diagram of a display according to an embodiment of the invention, in which a coupling relationship between a display 20 and electronic devices D1-DN and an input device 30 is illustrated. Referring to FIG. 2, the display 20 is, for example, a liquid crystal display (LCD), a light-emitting diode (LED) display, a field-emission display (FED) or other types of display. The electronic devices D1-DN can be PCs, table PCs, smart phones or other electronic devices. The input device 30 can be one of a keyboard (wired or wireless keyboard), a mouse (wired or wireless mouse), a touch pad, a motion sensor, or a combination thereof. The type of the display, the electronic devices and the input device are not limited by the invention.

A display panel 22 is, for example, an LCD panel, an LED panel, a FED panel or other types of display panel. A connection device 24 is, for example, a device having a plurality of connection ports of different specifications, and the connection ports respectively provide transmission interfaces of different specifications for receiving the frames output by various electronic devices. The transmission interfaces provided by the connection device 24 may support wired transmission, wireless transmission or a combination thereof, the wired transmission interface is, for example, a video graphics array (VGA) interface, a digital visual interface (DVI), a high-definition multimedia interface (HDMI), a mobility high-definition link (MHL), a display port (DP) interface, a thunderbolt interface, or a universal serial bus (USB), and the wireless transmission interface is, for example, an interface supporting a wireless transmission technique such as wireless fidelity (WiFi), bluetooth, infrared radiation (IR), near field communication (NF) or long term evolution (LTE).

Control keys 26 are, for example, a plurality of keys on the display 20, and when the user presses the control keys 26, an on-screen display (OSD) menu is displayed on the display panel 22. In the present embodiment, the OSD menu, for example, includes a list of all of the electronic devices connected to the display 20, and provides the user for selecting one of the electronic devices, so as to take the frame of the selected electronic device as the main control frame to implement subsequent operations.

A processor 28 is, for example, a scaler having a frame scaling function, a micro-controller unit (MCU), a central processing unit (CPU) or other hardware devices having computation capability. In the present embodiment, the processor 28 is coupled to the display panel 22, the connection device 24, the control keys 26 and the input device 30, and selects one of the frames as the main control frame according to frame allocating information, and displays the same on the display panel 22. Moreover, the processor 28 can further transmit an input signal of the input device 30 to the electronic device corresponding to the main control frame through the connection device 24, switch the main control frame among the frames displayed on the display panel 22 according to a trigger signal received from the control keys 26 or the input device 30, and transmit the input signal of the input device 30 to the electronic device corresponding to the switched main control frame through the connection device 24.

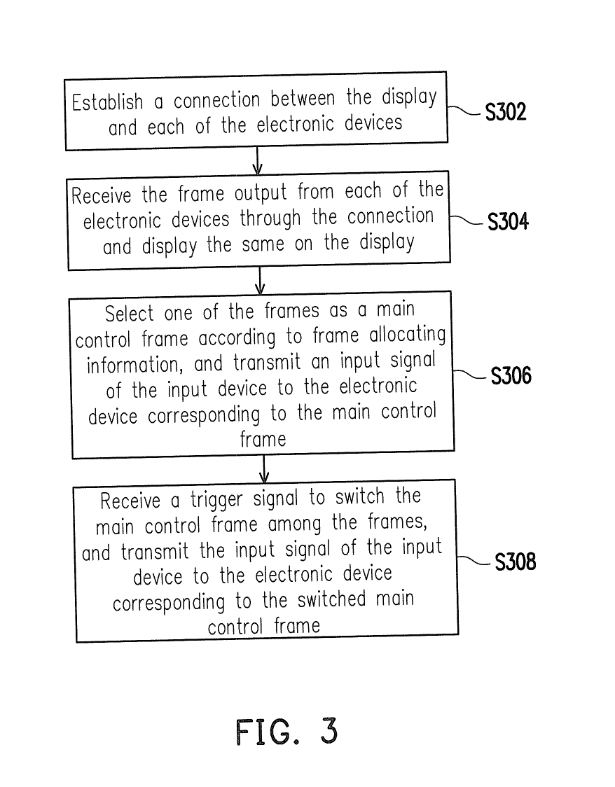

FIG. 3 is a flowchart illustrating a method for operating frames of multiple devices according to an embodiment of the invention. Referring to FIG. 2 and FIG. 3, the method is adapted for the aforementioned display 20, and a detailed flow of the method of the present embodiment is described below with reference of various components of the display 20 shown in FIG. 2.

First, the display 20 establishes connections with the electronic devices D1-DN through the connection device 24 (step S302), where the display 20 establishes the connections with the electronic devices D1-DN through the aforementioned wired or wireless approaches, which is not repeated herein.

Then, the processor 28 receives the frames output from each of the electronic devices D1-DN through the connection device 24 and displays the frames on the display 20 (step S304). In the present embodiment, the processor 28 can receive the frames of the electronic devices D1-DN, and simultaneously displays the frames on the display panel 22. The processor 28 can simultaneously display the frames of the electronic devices D1-DN in a form of overlapped frames, picture in picture (PIP), picture by picture (PBP), or picture on picture (POP), etc.

Then, the processor 28 selects one of the frames as the main control frame according to frame allocating information, and transmits an input signal of the input device 30 to the electronic device corresponding to the main control frame (step S306). In detail, the frame allocating information may record an allocation form that is adopted by the display 20 for displaying the frames of the electronic devices, for example, in case of an allocation form of overlapped frames, the frame allocating information can be information related to an upper and lower sequence of the overlapped frames, and in case of an allocation form of picture in picture, the frame allocating information can be information related to picture sizes. The processor 28 selects one of the frames of the electronic devices as the main control frame according to the aforementioned frame allocating information, and marks the main control frame on the display panel 22 by a thick frame for identification. Then, the processor 28 transmits the input signal of the input device 30 to the electronic device corresponding to the main control frame, such that the user can operate the electronic device corresponding to the main control frame through the input device 30. Embodiments are provided below to describe methods of switching the main control frame in case of the allocation forms of overlapped frames and picture in picture.

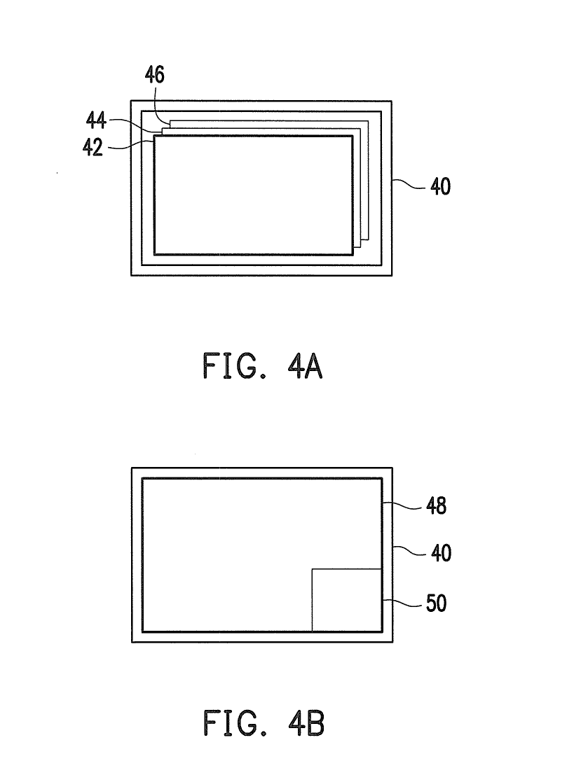

FIG. 4A and FIG. 4B are respectively examples of switching the main control frame among frames of multiple devices according to an embodiment of the invention. FIG. 4A illustrates a situation that a display 40 displays frames of three electronic devices in a form of overlapped frames. The display 40 displays frames 42-46 of the three electronic devices on the display 40 according to a connection sequence of the three electronic devices or a sequence that the three electronic devices connect the connection ports of the display 40, sets the frame 42 located on the top of the frames as the main control frame, and thickens edges of the frame 42 to indicate the same as the main control frame. FIG. 4B illustrates a situation that the display 40 displays frames 48 and 50 of two electronic devices in a form of picture in picture. The display 40 can set the frame 48 as the main control frame, and thicken the edges of the frame 48 to indicate the same as the main control frame. In this way, the user can operate the electronic device corresponding to the main control fame by using the connected input device (not shown).

Referring back to the flowchart of FIG. 3, the processor 28 receives a trigger signal, switches the main control frame among the frames of the electronic devices, and transmits the input signal of the input device 30 to the electronic device corresponding to the switched main control frame (step S308). In detail, in an embodiment, the trigger signal is generated when the user presses the control keys 26 on the display 20. In another embodiment, the trigger signal is generated when the user presses the hot key on the input device 30. After the processor 28 receives the trigger signal, the processor 28 switches the electronic device corresponding to the main control frame according to the trigger signal, and transmits the input signal of the input device 30 to the electronic device corresponding to the switched main control frame, such that the user can operate the electronic device corresponding to the main control frame through the input device 30. Embodiments are provided below to describe methods of switching the main control frame by using the control keys and the hot key.

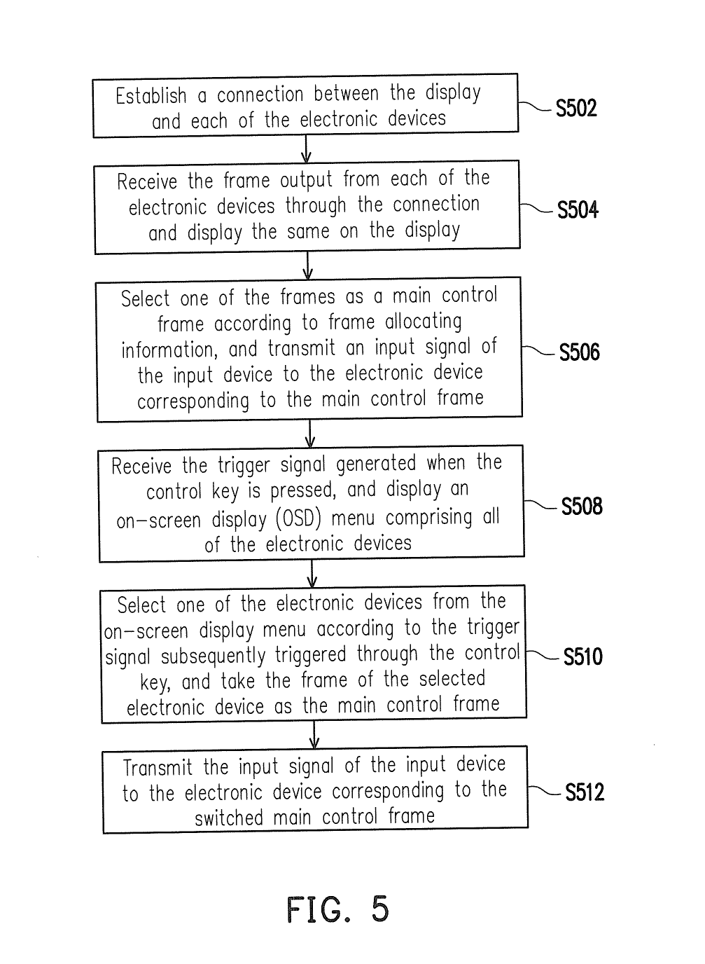

FIG. 5 is a flowchart illustrating a method for operating frames of multiple devices according to an embodiment of the invention. Referring to FIG. 2 and FIG. 5, the method is adapted for the aforementioned display 20, and a detailed flow of the method of the present embodiment is described below with reference of various components of the display 20 shown in FIG. 2.

First, the display 20 establishes connections with the electronic devices D1-DN through the connection device 24 (step S502). Then, the processor 28 receives the frames of the electronic devices D1-DN through the connection device 24 and displays the frames on the display panel 22 (step S504). Then, the processor 28 selects one of the frames as the main control frame according to frame allocating information, and transmits an input signal of the input device 30 to the electronic device corresponding to the main control frame (step S506). The steps S502-S506 are the same as or similar to the steps S302-S306 of the aforementioned embodiment, and details thereof are not repeated herein.

Different from the aforementioned embodiment, in the present embodiment, when the processor 28 receives the trigger signal triggered by the user through the control keys 26, the processor 28 displays an OSD menu including all of the connected electronic device on the display panel 22 according to the trigger signal (step S508). Then, the processor 28 selects one of the electronic devices from the OSD menu according to a trigger signal subsequently triggered through the control keys, and takes the frame of the selected electronic device as the main control frame (step S510). For example, the control keys 26 are, for example, a plurality of buttons located at a side edge of the display 20, for example, a menu button, an up button, a down button and a select button, etc. When the menu button is pressed by the user to generate the trigger signal, the processor 28 displays the OSD menu including all of the electronic devices D1-DN on the display 40 according to the trigger signal. Then, the user can move a cursor on the OSD menu to the desired electronic device by using the up and down buttons, and presses the select button to generate the trigger signal, such that the processor 28 can set the frame corresponding to the selected electronic device to the main control frame.

After switching of the main control frame is completed, the processor 28 transmits the input signal of the input device 30 to the electronic device corresponding to the switched main control frame (step S512), so as to facilitate the user operating the electronic device corresponding to the main control frame through the input device 30.

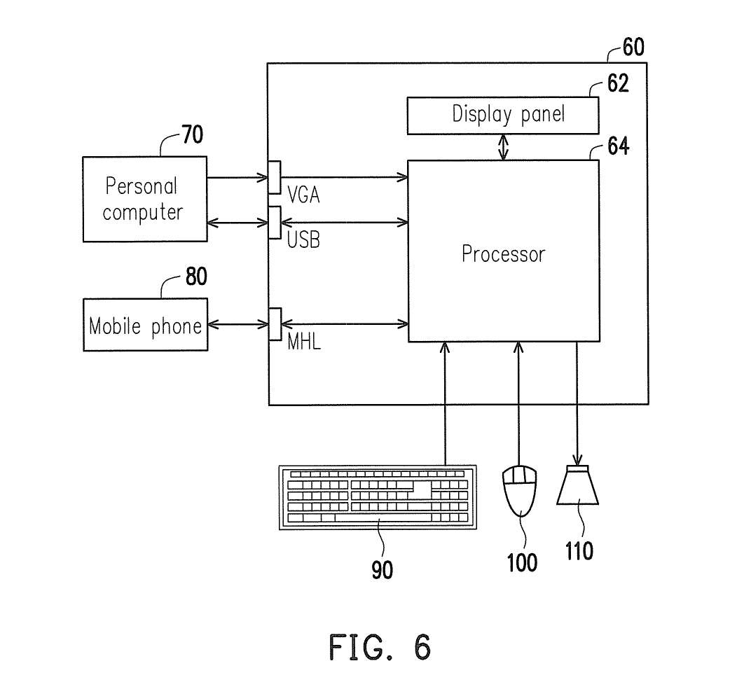

The method of switching the main control frame by using the hot key of the input device is described below. FIG. 6 is a block diagram of a display according to another embodiment of the invention, in which a coupling relationship between the display 60 and a plurality of electronic devices, an input device and an output device are illustrated. Referring to FIG. 6, in the present embodiment, the display 60 is coupled to a PC 70 and a mobile phone 80, and is coupled to a keyboard 90 and a mouse 100 that serve as the input devices, and is coupled to a speaker that serves as the output device, where the display 60 includes a display panel 62, a processor 64, and a VGA connection port, a USB connection port and an MHL connection port. The types and functions of the display panel 62 and the processor 64 are the same or as similar to those of the display panel 22 and the processor 28 in the aforementioned embodiment, and details thereof are not repeated.

Different from the aforementioned embodiment, in the present embodiment, the PC 70 is connected to the VGA connection port and the USB connection port of the display 60 through a VGA interface and a USB interface, where the processor 64 can receive a frame output by the PC 70 through the VGA connection port, and can be connected to the PC 70 through the USB connection port, so as to transmit the input signal of the keyboard 90 and the mouse 100 to the PC 70 for operating the frame output by the PC 70. On the other hand, the mobile phone 80 is connected to the MHL connection port of the display 60, where the processor 64 can receive a frame output by the mobile phone 80 through the MHL connection port, and transmits the input signal of the keyboard 90 and the mouse 100 to the mobile phone 80.

It should be noticed that in the present embodiment, besides that the keyboard 90 and the mouse 100 are connected to the processor 64 to transmit the signal generated by the keyboard 90 or the mouse 100 to the processor 64, a speaker 110 can also be connected to the processor 64 to output a sound signal generated by the processor 64.

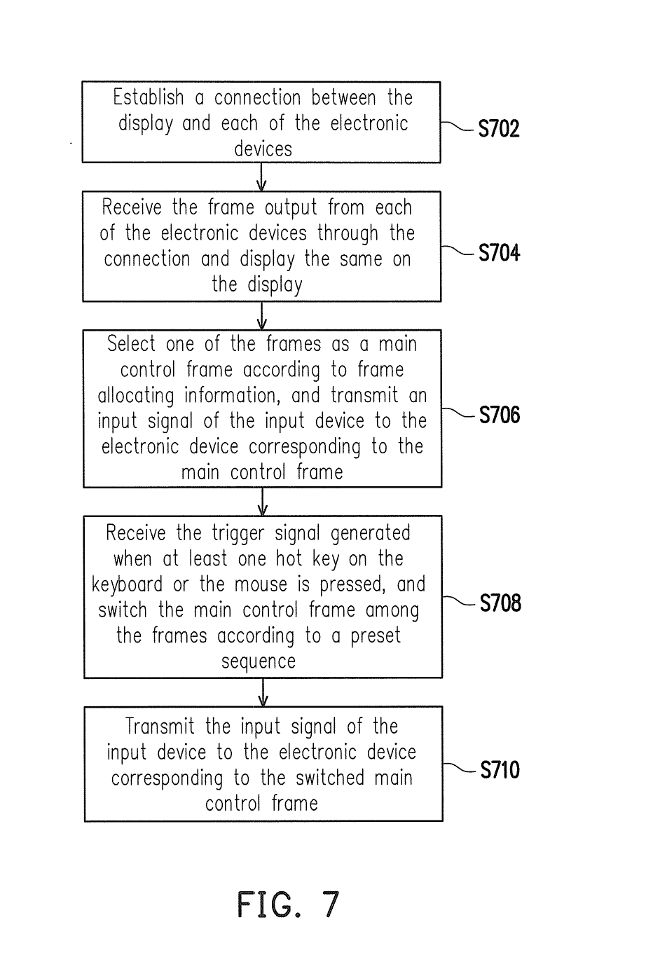

FIG. 7 is a flowchart illustrating a method for operating frames of multiple devices according to another embodiment of the invention. Referring to FIG. 6 and FIG. 7, the method of the present embodiment is adapted for the aforementioned display 60, and a detailed flow of the method of the present embodiment is described below with reference of various components of the display 60 shown in FIG. 6.

First, the display 20 establishes connections with the electronic devices (for example, the PC 70 and the mobile phone 80) through the connection ports (for example, the VGA, USB and MHL connection ports) (step S702). Then, the processor 64 receives the frames of the electronic devices through the connection ports and displays the frames on the display panel 62 (step S704). Then, the processor 64 selects one of the frames as the main control frame according to frame allocating information, and transmits an input signal of the keyboard 90 and the mouse 100 to the electronic device corresponding to the main control frame (step S706). The steps S702-S706 are the same as or similar to the steps S302-S306 of the aforementioned embodiment, and details thereof are not repeated.

Different from the aforementioned embodiment, in the present embodiment, the processor 64 can receive a trigger signal triggered when at least one hot key on the keyboard 90 or the mouse 100 is pressed, and switch the main control frame among the frames of different electronic devices according to a preset sequence (step S708). In detail, the hot key can be a number key, a letter key, one of function keys F1-F12, a Ctrl key, a Shift key, an Alt key, an Enter key or a composite key composed of the aforementioned keys (for example, Ctrl+number “1” or Ctrl+F1), which is not limited by the invention.

In an embodiment, when the user presses the hot key (for example, Ctrl key+F1 key) on the keyboard 90 to generate the trigger signal, the processor 28 displays the frame of the PC 70 on the display panel 62 to serve as the main control frame according to the trigger signal, and when the user presses the hot key (for example, Ctrl key+F2 key) on the keyboard 90 to generate the trigger signal, the processor 28 switches the frame of the mobile phone 80 to serve as the main control frame according to the trigger signal.

After switching of the main control frame is completed, the processor 64 transmits the input signal of the keyboard 90 and the mouse 100 to the electronic device corresponding to the switched main control frame (step S710), so that the user can operate the electronic device corresponding to the main control frame through the keyboard 90 and the mouse 100.

In summary, in the display and the method for operating frames of multiple devices of the invention, frames of a plurality of electronic devices are displayed on a single display according to a frame display technique of multiple devices of the display, and the user can select the frame corresponding to the electronic device to be controlled as the main control frame, so as to perform control operations on the frame of the electronic device by using the input device. Moreover, the user may use a control key on the display or a hot key on the input device to implement switching of the main control frame between the frames of different electronic devices. In this way, the user can quickly switch the electronic device to be controlled to implement operations.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A method for operating frames of multiple devices, adapted for a display to display frames of a plurality of electronic devices and operate the frame of each of the electronic devices by using an input device, the method comprising:
establishing a connection between the display and each of the electronic devices;
receiving the frame output from each of the electronic devices through the connection and displaying the frame on the display;
selecting one of the frames as a main control frame according to frame allocating information, and transmitting an input signal of the input device to the electronic device corresponding to the main control frame; and
receiving a trigger signal to switch the main control frame among the frames, and transmitting the input signal of the input device to the electronic device corresponding to the switched main control frame.

2. The method for operating frames of multiple devices as claimed in claim 1, wherein the step of selecting one of the frames as the main control frame according to the frame allocating information comprises:
overlapping the frames, and displaying the main control frame on the top of the frames.

3. The method for operating frames of multiple devices as claimed in claim 1, wherein the step of selecting one of the frames as the main control frame according to the frame allocating information comprises:
displaying the frames in a form of picture in picture (PIP), picture by picture (PBP), or picture on picture (POP), and marking the main control frame.

4. The method for operating frames of multiple devices as claimed in claim 1, wherein the display further comprises at least one control key, and the step of receiving the trigger signal to switch the main control frame among the frames comprises:
receiving the trigger signal generated when the control key is pressed, and displaying an on-screen display (OSD) menu comprising all of the electronic devices; and
selecting one of the electronic devices from the on-screen display menu according to the trigger signal subsequently triggered through the control key, and taking the frame of the selected electronic device as the main control frame.

5. The method for operating frames of multiple devices as claimed in claim 1, wherein the input device comprises a keyboard or a mouse, and the step of receiving the trigger signal to switch the main control frame among the frames comprises:
receiving the trigger signal generated when at least one hot key on the keyboard or the mouse is pressed, and switching the main control frame among the frames according to a preset sequence.

6. A display, comprising:
a connection device, establishing connections with a plurality of electronic devices, and receiving frames output from the electronic devices;
a display panel, displaying the frames received by the connection device;
an input device, generating an input signal in response to an operation; and
a processor, coupled to the connection device, the display panel and the input device, and selecting one of the frames as a main control frame according to frame allocating information, transmitting the input signal to the electronic device corresponding to the main control frame, switching the main control frame among the frames according to a trigger signal, and transmitting the input signal to the electronic device corresponding to the switched main control frame.

7. The display as claimed in claim 6, wherein the processor overlaps the frames on the display panel, and displays the main control frame on the top of the frames.

8. The display as claimed in claim 6, wherein the processor displays the frames in a form of picture in picture (PIP), picture by picture (PBP), or picture on picture (POP), and marks the main control frame.

9. The display as claimed in claim 6, further comprising:
at least one control key, being pressed to trigger the trigger signal, wherein
when the trigger signal is received, the processor displays an on-screen display (OSD) menu comprising all of the electronic devices on the display panel, selects one of the electronic devices from the on-screen display menu according to the subsequently received trigger signal, and takes the frame of the selected electronic device as the main control frame.

10. The display as claimed in claim 6, wherein the input device comprises a keyboard or a mouse, wherein
the processor receives the trigger signal generated when at least one hot key on the keyboard or the mouse is pressed, and switches the main control frame among the frames according to a preset sequence.

11. The display as claimed in claim 6, wherein the connection device comprises one of a video graphics array (VGA) interface, a digital visual interface (DVI), a high-definition multimedia interface (HDMI), a mobility high-definition link (MHL), a display port (DP) interface, a thunderbolt interface and a universal serial bus (USB) or a combination thereof.

12. The display as claimed in claim 6, wherein the connection device comprises a wireless transmission device supporting a communication technique of wireless fidelity (WiFi), bluetooth, infrared radiation (IR), near field communication (NF) or long term evolution (LTE).
